(19) United States
(12) Patent Application Publication
(10) Pub. No.: US 2006/0007483 A1
(43) Pub. Date: Jan. 12, 2006

(54) Image taking apparatus, image generating apparatus, image displaying apparatus, image printing apparatus, image taking method, image generating method, control program, and computer-readable storage medium

(75) Inventor: Hiroshi Tanaka, Kyoto (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/175,043

(22) Filed: Jul. 6, 2005

(30) Foreign Application Priority Data
Jul. 6, 2004 (JP) 2004-199933

(51) Int. Cl. G06F 15/00

(52) U.S. Cl. 358/1.15

(57) ABSTRACT

The image taking apparatus of the present invention includes: an image taking section for taking a still image or moving image; a direction indicating section for designating a direction of an image while the image is being taken; and an image recording section for recording the direction designated by the direction indicating section as direction indication information with image data taken by the image taking section.

This Nonprovisional application claims priority under 35 U.S.C. §119(a) on Patent Application No. 2004-199933 filed in Japan on Jul. 6, 2004, the entire contents of which are hereby incorporated by reference.

### BACKGROUND OF THE INVENTION

1. Field of the Invention

The present invention relates to: an image taking apparatus which can take digital images such as digital cameras, digital video cameras, camera-equipped cell-phones and the like, and an image taking method using the same; an image generating apparatus for generating display data or print data from image data obtained by such an image taking apparatus, and an image generating method using the same; an image displaying apparatus for displaying display data obtained by such an image generating apparatus on a monitor; an image printing apparatus for printing print data obtained by such an image generating apparatus on paper by a printer or the like; a control program for processing such methods on a computer; and a readable storage medium having such a control program stored therein.

2. Description of the Related Art

Recently, digital cameras have become popular. Conventionally, they have been used for viewing taken video (images) on a personal computer (PC). Instead, using a television as a monitor which is suitable for being viewed by more people is becoming more common. Since increase in use of the digital cameras, digital video cameras and camera-equipped cell-phones, is significant, communication methods such as sending/receiving taken image data (picture) via communication path for fun is becoming common.

Such expansion is largely due to price-reduction of equipment, but is also due to miniaturization of shooting equipment such as camera-equipped cell-phones, digital cameras and the like. As a result, flexibility in shooting method is increasing. For example, equipment can be used in a horizontal position or a vertical position. Thus, taken images include both vertically long images whose upper side in a narrow side and a horizontally long image whose upper side is a wide side.

When such taken images are viewed using a personal computer (PC), television set (TV) or the like, no problem occurs when original top of the taken images are on the same side as the top of the displaying equipment. However, when the original top of the taken images and the top of the displaying equipment are not on the same side, there is a problem that, for example, the top portion of an image when the image was taken is positioned on the left or right side of the displaying apparatus.

In order to solve such a problem, for example, Japanese Laid-open Publication No. 2002-218383 discloses a digital camera which includes designation means for designating directions of image data to be stored and image direction converting means for converting the direction of taken image data to the designated direction, and which stores image data in which the direction of the image is converted to the instructed direction using the means for converting the direction of the image data. Such a digital camera allows storing the image data in a direction intended by a shooting person by being designated by the shooting person which of the sides is the top of the image when the image is taken.

The conventional technique disclosed in Japanese Laid-open Publication No. 2002-218383 allows reproducing taken images in directions intended by the shooting person of the images but may have the following problems depending upon use conditions.

For example, it is difficult to mount a signal processing apparatus which can process at high speed to electronic information equipment which is generally referred to as embedded devices such as digital cameras in view of consumption power and cost. The image direction conversion means disclosed in Japanese Laid-open Publication No. 2002-218383 performs a signal process for an output from an image data buffer. For performing such an image direction conversion process during shooting, a process which has not been necessary is added. Thus, it is required to mount a system which can process at high speed so that the process can be performed at a similar speed as that in conventional techniques, even when such an image conversion process is added.

However, it is not preferable that a process takes time when images are being taken since there is a strong demand to shoot the moment compared to the time when images are being reproduced. Images are often taken outside using a battery. Thus, a method which requires a large amount of power for the image conversion process is not appropriate.

Further, there is also a problem that throughput increases as pixel count increases since a process in proportion to the pixel count is necessary for image conversion.

Recently, even cameras mounted to cell phones have two million pixels in general. Sometimes, even digital cameras having six million pixels are used. It is expected that such a trend of increasing pixel count will become stronger in future. Thus, there is a problem in the method in which the throughput increases in proportion to the pixel count.

Furthermore, it is not referred to in Japanese Laid-open Publication No. 2002-218383, but this conventional technique has the following problems when applied to moving images. This method is not practical for image conversion of a moving image of a long time period since a time period necessary for the image conversion process is proportional to time period during the moving image is being taken. Therefore, a method is desired which has a low throughput to be suitable for embedded devices and the like, and which is applicable to moving images.

Moreover, in the conventional technique disclosed in Japanese Laid-open Publication No. 2002-218383, taken images include both vertically long images and horizontally long images. When the taken images are printed and seen, images can be seen in any direction by rotating printed material. Thus, whether the original image is horizontally long or vertically long does not cause any problem. However, when there are both vertically long images and horizontally long images, some printers may print a horizontally long image even when paper is prepared in the vertically long direction, or vice versa. Therefore, for printing taken images at one time, a cumbersome process is required. For example, images are first grouped into vertically long images and horizontally long images by the user, and then, each of the groups is printed.

Moreover, this method also requires designating the direction of an image when the image to being taken in addition to pressing a shutter button which is necessary for normal shooting. This method allows designating the vertical directions of taken images. However, since operability and procedure are significantly different from those of normal cameras, it takes time for a user to get used to the operation, and there is a possibility that the user to designate a direction different from the intended direction.

### SUMMARY OF THE INVENTION

According to one aspect of the present invention, an image taking apparatus includes: an image taking section for taking a still image or moving image; a direction indicating section for designating a direction of an image while the image is being taken; and an image recording section for recording the direction designated by the direction indicating section as direction indication information with image data taken by the image taking section.

In one embodiment of the present invention, an image taking apparatus further includes a sending/receiving section which allows sending/receiving of the direction indication information with the image data via a communication path.

In one embodiment of the present invention, the direction indicating section also serves as a shutter button or a recording start button, and a plurality of the direction indicating sections are provided so an to be associated with the direction of the image.

In one embodiment of the present invention, the direction of the rotation is a vertical direction of the image.

According to another aspect of the present invention, an image generating apparatus for generating display data from the image data taken by the image taking apparatus described above, includes: an image data storing section for storing the direction indication information with the image data; a direction referring section for referring to the direction indication information from the image data storing section; an image forming section for reading out the image data from the image data storing section and rotating the image data as necessary in accordance with the direction of the image based on the direction indication information referred to by the direction referring section to generate display data.

According to another aspect of the present invention, an image displaying apparatus includes: an image generating apparatus described above; and a displaying section for displaying the display data generated by the image generating apparatus on a display screen.

According to another aspect of the present invention, an image generating apparatus for generating print data from the image data taken by the image taking apparatus described above, includes: an image data storing section for storing the image data; and an image forming section for reading out the image data from the image data storing section and generating print data irrespective of the direction indication information.

According to another aspect of the present invention, an image printing apparatus includes: an image generating apparatus described above; and a printer section for printing the print data generated at the image generating apparatus on paper.

According to another aspect of the present invention, an image taking method includes the steps of: (a) taking a still image or a moving image; (b) allowing output of direction indicating instruction which designates a direction of an image while the image is being taken; and (a) recording and storing the direction designated to be output in step (b) as direction indication information with image data taken in step (a).

In one embodiment of the present invention, an image taking method further includes the step of receiving/sending the direction indication information with the image data via a communication path.

According to another aspect of the present invention, an image generating method for generating display data from the image data obtained by the image taking method described above, includes the steps of: (d) referring to the direction indication information stored with the image data; and (e) reading out the image data and rotating the image data as necessary in accordance with the direction of the image based on the direction indication information referred to in step (d) so as to generate display data.

According to another aspect of the present invention, an image generating method for generating print data from the image data obtained by the image taking method described above, includes the step of reading out the image data and generating print data irrespective of the direction indication information.

According to another aspect of the present invention, a control program is provided for operating a computer to perform the steps of the image taking method as described above.

According to another aspect of the present invention, a control program for operating a computer to perform the steps of the image generating method as described above.

According to another aspect of the present invention, a computer-readable storage medium having the control program as described above stored thereon, is provided.

Thus, the invention described herein makes possible the advantages of providing image taking apparatus, image generating apparatus, an image displaying apparatus, an image printing apparatus, an image taking method, an image generating method, a control program for processing the method, and a computer readable storage medium having the control program stored therein, which have low throughput, can be applied to moving pictures, and for which image reproduction can be readily performed in a direction as intended by a user of the image taking apparatus.

In view of the above-described structure, hereinafter, effects of the present invention will be described.

According to the present invention, unlike Japanese Laid-open Publication No. 2002-218383, the taken image data is not stored with the direction of the image data (direction of the image) being changed, but is stored as the image data itself without changing the direction. As an attribute information of the taken image, direction indication information indicating an original upper side (or lower side) (vertical direction) of the image is instructed by a user of the image taking apparatus, and the instructed direction indication information is stored with the image data. When the image data is displayed, the image data is rotated (i.e. the direction of the image is changed) as necessary with reference to the direction indication information to generate display data.

Compared to the process of converting the direction of image data as in Japanese Laid-open Publication No. 2002-218383, the throughput when images are taken is significantly smaller since only the direction indication information for setting the vertical direction of the image is stored with the image data. When the still image is taken, in a similar manner as the moving image, the information indicating the upper side (or lower side) can be stored as an attribute when the image is reproduced. Furthermore, even in the case where equipment (for example, a camera) is rotated in the middle of a shooting process, if the upper side when the image is taken does not change, a process time for setting the vertical image is constant even for a moving image of a long time period. The throughput can thus be small.

Therefore, a process for shooting can be minimized, and it is not necessary to use a signal process apparatus which can process at a high speed for thia purpose. In general, in a signal process of a digital image, an encoding process during shooting has larger throughput than a decoding process during reproduction. Thus, adding a process performed during shooting often affects performances of the equipment.

However, in equipment in which throughput at decoding is smaller than that at encoding and which can perform both encoding processes and decoding processes, some increase in the throughput at decoding does not affect the system structure of the equipment. This shows that it is preferable to perform processes during reproduction and/or referencing rather than performing more processes during recording and/or shooting.

A signal process time according to the present invention does not depend on shooting time of a moving image as described above. The process time does not increase depending upon the pixel count in the case of still images. This is because the direction of the image data is not changed when the image is taken.

Since the direction of the image data is not changed when the image is taken, therein also a benefit in printing images. For example, the image printing apparatus can process all the images as, for example, horizontally long images, by not depending upon the direction indication information indicating the vertical direction of the image data but generating print data without rotating the image. Once the images are rotated, both the vertically long images and the horizontally long images may exist. However, according to the present invention, although there are both values in the attribute information indicating direction (direction indication information), there is only one direction of the image, and the images can be handled as horizontally long images or vertically long images. Thus, when the images are printed by a printing apparatus or the like, it is not necessary to consider the direction of the image, and to match the direction of the paper and the direction of images.

In the present invention, as the direction indicating section, a dedicated direction indicating apparatus may be provided, or a shutter button or a recording start button of video cameras may also serve as the direction indicating section. For example, shutter buttons or recording start buttons may be provided at multiple positions of the shooting equipment, and the vertical direction may be decided depending upon which of the buttons is used. Normally, when cameras are hold, shutter buttons often locate on the upper right corner.

Therefore, it is possible to set that, when a button on the upper right corner of the camera is used, the upper side of the normal camera as the upper side of the taken image. It is possible to set that, when the button on the lower right corner of the camera is used, the right side of the image as the upper side when the image is displayed since such a shutter button can be easily pressed when the camera is held vertically.

As described above, according to the present invention, not only the still images but also the moving images can be reproduced in the direction intended by a user of the image taking apparatus. In such cases, the throughput during shooting and/or recording can be minimized. Thus, operating with an equipment structure and power consumption similar to those in the conventional art is possible.

Since the direction of the image data is not changed when the image is taken, it is not necessary to set paper both in a vertical direction and in a horizontal direction, or to perform a printing process with the images being separated into groups of different types of images.

If a shutter button or a recording start button also serves as the direction indicating section shutter button, a special process for designating the vertical direction when the image is reproduced is no longer necessary. This has a benefit that the user does not get confused during operation.

The present invention can apply not only to still images but also to moving images. When the moving image is being taken, the vertical direction of the image can be designated for reproduction without the process time being proportional to shooting time. This may contribute to reducing the electric power consumption of the equipment. Therefore, the present invention is significantly effective, especially when reducing electric power consumption is required, such as in equipment for handling moving images such as IP video phones.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing an exemplary basic structure of an image taking apparatus of Embodiment 1-1.

FIG. 2 is a block diagram showing an exemplary specific hard structure (exemplary implementation) of the image taking apparatus 10 of FIG. 1.

FIG. 3 is a flow diagram showing a process procedure of an image taking operation in the image taking apparatus 10 of FIG. 1.

FIG. 4 in a block diagram showing an exemplary basic structure of an image displaying apparatus of Embodiment 1-2.

FIG. 5 is a flow diagram showing a process procedure of an image displaying operation by the image displaying apparatus of FIG. 4.

FIG. 6 is a block diagram showing an exemplary basic structure of an image printing apparatus of Embodiment 1-3.

FIG. 7 is a flow diagram showing a process procedure of an image printing operation by the image printing apparatus of FIG. 6.

FIG. 8 is a block diagram showing an exemplary structure of an image taking apparatus of Embodiment 2-1.

FIG. 9 is a flow diagram showing a process procedure of an image taking operation of the image taking apparatus of FIG. 8.

FIG. 10 is a block diagram showing an exemplary structure of an image displaying apparatus of Embodiment 2-2.

FIG. 11 is a flow diagram showing a process procedure of an image displaying operation by the image displaying apparatus of FIG. 10.

FIG. 12 is a block diagram showing an exemplary basic structure of an image printing apparatus of Embodiment 2-3.

FIG. 13 is a flow diagram showing a process procedure of an image printing operation by the image printing apparatus of FIG. 12.

FIG. 14 is a schematic diagram showing an operating section in an image taking apparatus of Embodiment 3.

FIG. 15 is a schematic diagram showing an operating section when the image taking apparatus of FIG. 14 is held vertically for shooting.

FIG. 16 is a flow diagram showing a process procedure of a program when the image taking apparatus of FIG. 14 is a digital camera for taking still images.

FIG. 17 is a flow diagram showing a process procedure of a control program when the image taking apparatus of FIG. 14 is a digital video camera.

### DESCRIPTION OF THE PREFERRED EMBODIMENTS

Hereinafter, Embodiments 1-1, 2-1 and 3 of an image taking apparatus according to the present invention, Embodiments 1-2 and 2-2 of an image displaying apparatus including an image generating apparatus according to the present invention, and Embodiments 1-3 and 2-3 of an image printing apparatus including an image generating apparatus of the present invention will be described in detail with reference to the drawings.

### Embodiment 1-1

In Embodiment 1-1, an image taking apparatus for still images, in which information indicating an original upward (or downward) direction (i.e., vertical direction) is designated by a person who shoots an image as one of attribute information of the taken still image, and the direction indication information is stored with still image data, will be described.

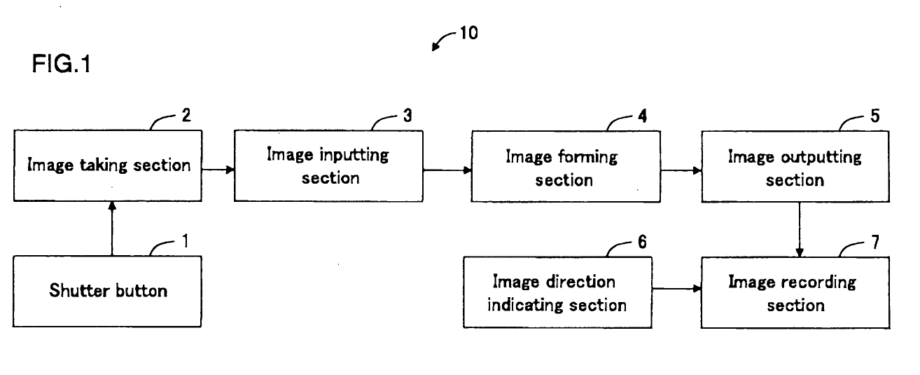

FIG. 1 is a block diagram showing an exemplary basic structure of an image taking apparatus of Embodiment 1-1.

As shown in FIG. 1, an image taking apparatus 10 includes a shutter button 1, an image taking section 2, an image inputting section 3, an image forming section 4, an image outputting section 5, a direction indicating section 6, and an image recording section 7. A still image itself taken by the image taking section 2 is stored in the image recording section 7 as it is without changing the direction. As an attribute information of the taken still image, direction indication information, which is information indicating an original upward (or downward) direction (i.e., vertical direction) designated to be input by a user of the image taking apparatus from the direction indicating section 6, is stored in the image recording section 7 with image data.

In such a structure, when shooting is instructed by an operation of the shutter button 1 by an operator, an image is taken by the image taking section 2. The taken image is input to the image inputting section 3 as image data. The image data input from the image inputting section 3 is formed into image data representing an actual image by the image forming section 4. For example, Bayer data of CCD is converted into RGB data. The image data formed by the image forming section 4 is stored in the image recording section 7, ouch as an external memory card, via the image outputting section 5.

The functions of the apparatus are similar to those of normal digital cameras so far. However, the image taking apparatus 10 of Embodiment 1 is different in that the direction indication information which indicates the vertical direction of the image (direction of the image) designated by the direction indicating section 6 is stored in the image recording section 7 with the image data of the taken still image.

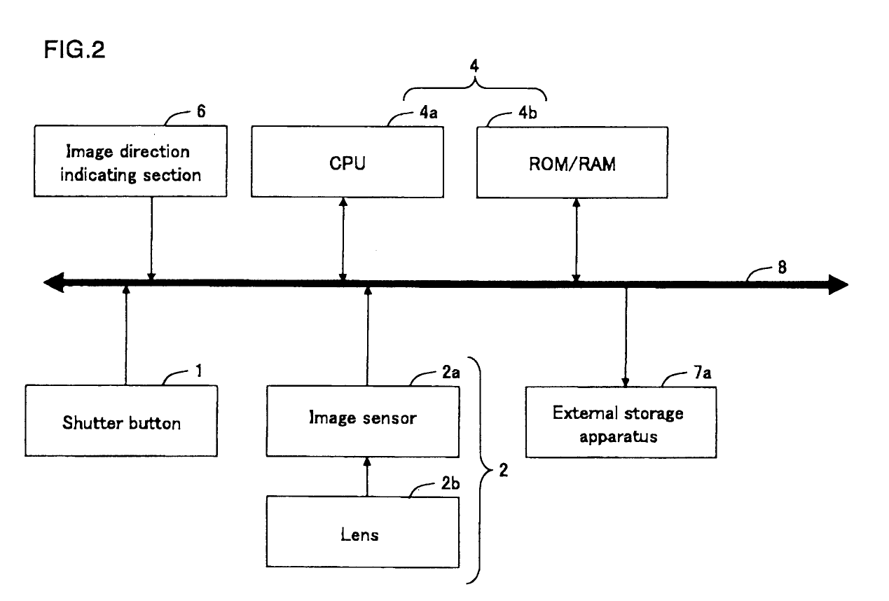

FIG. 2 is a block diagram showing an exemplary specific structure of the image taking apparatus 10 of FIG. 1.

As shown in FIG. 2, the image taking apparatus 10 includes the shutter button 1, the image taking section 2 having an image sensor 2a and a lens 2b, the image forming section 4 having a CPU 4a and an internal memory including a ROM/RAM 4b, the direction indicating section 6, and an external storage device 7a as the image recording section 7 which are respectively connected via bus line 8.

Processes in the image taking apparatus 10 are controlled by the CPU 4a using a control program stored in the ROM of the ROM/RAM 4b and data used for it.

When the operator presses the shutter button 1, an interrupt signal is sent to the CPU 4a via the bus line 8. The CPU 4a temporarily stores the image data stored to the image sensor 2a through the optical lens 2b in the RAM of the ROM/RAM 4b. The image data stored in the RAM is subjected to an appropriate image processing by the CPU 4a, and stored in the external storage device 7. For storing the taken image (picture) as image data, information indicating vertical direction of the image (direction indication information) which is designated from the direction indicating section 6 is obtained, and the direction indication information is written into the external storage device 7a. The image data and the direction indication information may be sent/received via the communication path with a sending/receiving section (not shown) further provided.

In view of the above-described structure, an image taking operation of the image taking apparatus 10 of Embodiment 1 will be described.

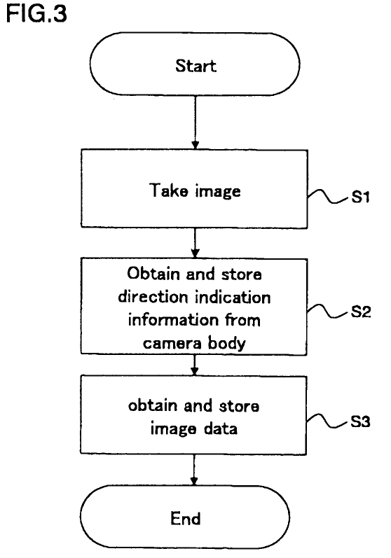

FIG. 3 is a flow diagram showing a process procedure of the image taking operation in the image taking apparatus 10 of FIGS. 1 and 2. The process procedure is stored in, for example, the ROM of the ROM/RAM 4b as a control program. The CPU 4a refers to the control program to perform the process.

As shown in FIG. 3, in step S1, an image taking process is performed by a process procedure similar to that of normal digital cameras by pressing the shutter button 1.

Next, in step S2, direction indication information is obtained and stored. Thus, when a shooting process is performed, information indicating the vertical direction of the image (the upper side or lower side of the image) (direction indication information) which is designated to be input from the direction indicating section 6 by the user is obtained, and the information is stored in the external storage device 7a with the image data as one of attributes of the image data.

Then, in step S3, the image data is obtained and stored with a process procedure similar to that in normal digital cameras.

As described above, according to Embodiment 1, an image itself is stored as image data as it is taken without changing the direction (direction of the image) at a signal process when the image is taken. As an attribute information of the taken image, the direction indication information which indicates the original upward (or downward) direction (vertical direction) of the image is designated to be input by a user of the image taking apparatus. Then, the direction indication information which is designated to be input is stored with the image data. Therefore, a process when the image is taken can be minimized, and a signal processing apparatus which can process at high speed is not necessary as in the conventional art.

### Embodiment 1-2

In Embodiment 1-2, an image displaying apparatus, in which reference to direction indication information is made when a taken image is displayed and image data is rotated as necessary to generate display data, will be described.

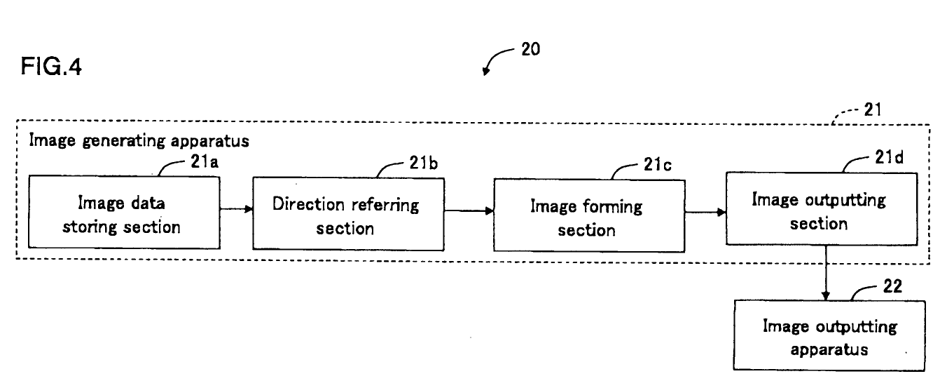

FIG. 4 is a block diagram showing an exemplary basic structure of an image displaying apparatus of Embodiment 1-2.

As shown in FIG. 4, the image displaying apparatus 20 has an image generating apparatus 21 including an image data storing section 21a, a direction referring section 21b, an image forming section 21a, and an image outputting section 21d, and an image outputting apparatus 22 as a displaying section. The image displaying apparatus 20 displays a still image on the display screen with the direction of the taken image being designated.

The image data storing section 21a is formed of, for example, an external memory card or the like, and stores image data taken by the image taking apparatus 10 of the present invention. In the image data storing section 21a, information indicating the direction along which the image should be displayed (direction indication information; location information of the upper side or lower side of the image) is also stored with the image data. Reference to the direction indication information is made by the direction referring section 21b.

In the image forming section 21a, image data stored in the image data storing section 21a is read out, and the image is rotated as necessary such that the side which should be on the upper (or lower) side is displayed on the upper (lower) aide in accordance with the direction indication information from the direction referring section 21b to form the display data. If it is not necessary, the image is not rotated and is formed as display data as it is. The display data is output from the image outputting section 21d, and is sent to the image outputting apparatus 22 ouch as a liquid crystal display device. The process of rotating the image can be performed using conversion process methods which have been conventionally used. Thus, it is not described in detail herein.

When reference to the taken image data is made by television equipment, for example, screen display on equipment is not necessary. Thus, in such a case, the image outputting apparatus 22 is not provided, and instead, the apparatus may be formed as an image generating apparatus which is the image generating apparatus 21 including only the image data storing section 21a, the direction referring section 21b, the image forming section 21c, and the image outputting section 21d. In this case, an output signal from the image outputting section 21d is sent to the external display device such as television equipment in an appropriate format, and is displayed on the display screen.

In view of the above-described structure, hereinafter, an image displaying operation by the image displaying apparatus 20 of Embodiment 1-2 will be described.

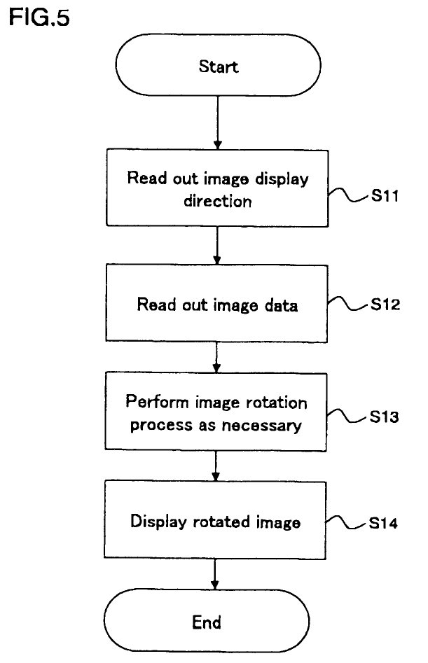

FIG. 5 is a flow diagram showing a process procedure of the image displaying operation by the image displaying apparatus 20 of Embodiment 1-2. The process procedure is stored in, for example, a ROM provided in the image forming section 21a as a control program. A CPU provided in the image forming section 21c refers to the control program, and process steps are performed.

As shown in FIG. 5, first, in step S11, direction indication information which is one of the attributes of the image data stored in the image data storing section 21a is read out to the direction referring section 21b.

Next, in step S12, the image data stored in the image data storing section 21a is read out to the image forming section 21c. These operations may be performed in the reversed order.

Then, in step S13, for forming the image data read out at step S12 by the image forming section 21a, reference to the direction indication information read out at step S11 is made, and the image is rotated as necessary in accordance with the information. In some cases, it is not necessary to rotate the image depending upon the direction of the camera when the image is taken. In such cases, the image is displayed without being rotated. The same is also true of the case where no direction indication information indicating the vertical direction of the image exists.

Thereafter, in step 814, the image data after rotation (display data) is supplied to the image outputting apparatus 22, and the image is displayed on the display screen.

As described above, according to Embodiment 2, when an image taken by the image taking apparatus 10 is displayed, the image data can be rotated as necessary with reference to the direction indication information to generate display data. In this way, the image can be reproduced in the direction intended by the user of the image taking apparatus.

### Embodiment 1-3

In Embodiment 1-3, an image printing apparatus will be described, in which still images of the same shape having the wide sides and narrow sides on the same side, which are taken by the image taking apparatus 10, are printed since reference is made to only the image data and the images are not rotated as in the case for displaying the images depending upon the direction indication information.

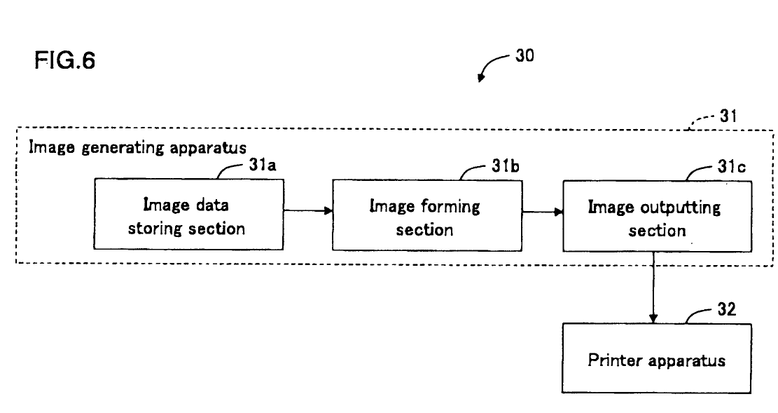

FIG. 6 is a block diagram showing an exemplary basic structure of an image printing apparatus of Embodiment 1-3.

As shown in FIG. 6, an image printing apparatus 30 has: an image generating apparatus 31 including an image data storing section 31a, an image forming section 31b, and an image outputting section 31c; and a printer apparatus 32 as a printing section. The image printing apparatus 30 prints still images of the same shape having the wide sides and narrow sides on the same aide, which are taken by the image taking apparatus 10.

The image data storing section 31a may be, for example, external memory cards, and stores image data of still images taken by the image taking apparatus 10 of Embodiment 1-1.

The image data storing section 31a also stores information indicating the direction along which the image should be displayed (direction indication information) with the image data. In Embodiment 1-3, the direction indication information is not used, and only the image data is used.

This image data is image data itself as it is taken by the digital camera. Thus, in the case where the horizontal direction is a normal image direction, when an image is taken by the image taking apparatus 10 of Embodiment 1-1 and it is designated that the direction indication information points the direction different from the normal image direction, the image becomes a horizontally long image taken by the same type of digital camera. As such, irrespective of content of image, horizontally long images of the same shape (having the same number of pixels in both vertical direction and horizontal direction) are obtained. When the image display direction in not considered, images taken by the same type of digital camera does not include both vertically long images and horizontally long images.

In the image forming section 31b, the image data stored in the image data storing section 31a is read out and formed as print data. The image outputting section 31a converts the print data into printer control data suitable for the printer apparatus 32 and sent out to the printer apparatus 32.

In Embodiment 1-3, the image forming section 31b forms image data, and the image outputting section 31c converts the image data into data suitable for the printer apparatus 32. However, the border between the image forming section 31b and the image outputting section 31a may be vague in some cases. Even in such cases, reference is made to only the image data among the image data stored in the image data storing section 31a and the direction indication information, and the image is not rotated unlike when images are displayed.

In view of the above-described structure, hereinafter, an image printing operation by the image printing apparatus 30 of Embodiment 1-3 will be described.

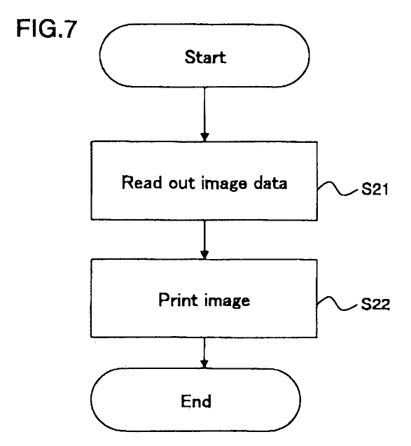

FIG. 7 is a flow diagram showing a process procedure of the image printing operation by the image printing apparatus 30 of Embodiment 1-3. The process procedure is stored in, for example, a ROM provided in the image forming section 31b as a control program. The control program is referred to by a CPU provided in the image forming section 31b to perform process steps.

As shown in FIG. 7, in step S21, similarly to a normal still image generating apparatus for a printer, the image data stored in the image data storing section 31a is read out to the image forming section 31b to form image date. The image data is converted by the image outputting section 31c into the data suitable for the printer apparatus 32. Even when the direction indication information exists with the image data, the direction indication information is not used, and the image is not rotated.

Then, in stop S22, the image data (print data) is supplied to the printer apparatus 32, and the image is printed on paper.

As described above, according to Embodiment 1-3, the reference is made to only the image data among the image data and the direction indication information, and the image is not rotated as in the case when the image is being displayed depending upon the direction indication information. Thus, images as they are taken by the image taking apparatus 10 which have the same shape with the wide side and narrow side on the same side can be obtained. Accordingly, for feeding paper to the printer apparatus 32, it is not necessary to switch paper depending upon the images. An inexpensive printer apparatus 32 which cannot perform automatic paper selection requires effort in switching paper when paper in both the vertical direction and the horizontal direction is used. However, when the images are output along one same direction, paper may be fed to the printer apparatus 32 in one direction. Since it is easy to rearrange the direction of paper after printing manually, effort and cost can be saved.

### Embodiment 2-1

In Embodiment 2-1, an image taking apparatus for moving image in which information indicating an original upper side (or lower side) (vertical direction is designated to be input by a user as an attribute information of taken moving images, and the direction indication information designated to be input is stored with moving image data. In Embodiment 1-1, still images are taken. However, in Embodiment 2-1, moving images are taken.

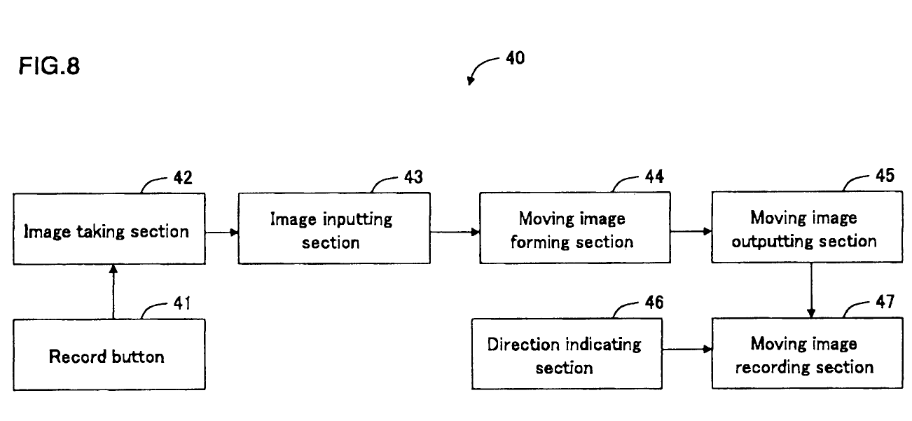

FIG. 8 is a block diagram showing an exemplary structure of an image taking apparatus of Embodiment 2-1.

As shown in FIG. 8, an image taking apparatus 40 includes a record button 41, an image taking section 42, an image inputting section 43, a moving image forming section 44, a moving image outputting section 45, a direction indicating section 46, and a moving image recording section 47. The image taking apparatus 40 stores a moving image as it is taken by the image taking section 42 in the moving image recording section 47 without changing the direction, and stores direction indication information, which is information indicating original upper side (or lower side) (vertical direction) which is designated to be input by the user from the direction indicating section 46, in the moving image recording section 47 as one of attribute information of the taken moving image with the image data. Basically, the structure of the image taking apparatus 40 is the same as that shown in FIG. 1 with a portion which supports still images in FIG. 1 being made to support moving images.

In the above-described structure, recording of moving images is started by operating the button 41. When recording of moving images is started, image taken by the image taking section 42 is input to the image inputting section 43 as image data. The image data input from the image inputting section 43 is formed into image data representing an actual image by the moving image forming section 44. The image is converted from, for example, Bayer data of CCD to RGB data of three primary color data. The image data formed at the moving image forming section 44 is stored in the moving image recording section 47, such as an external memory card, via the moving image outputting section 45.

The image taking apparatus 40 so far has no big difference from normal digital video cameras and the like. However, in the image taking apparatus 40 of Embodiment 2-1, the direction indication information indicating the vertical direction of the image which is designated by the direction indicating section 46 is further recorded in the moving image recording section 47 with the image data. The image data and direction indication information may be sent/received by transmission on a communication path with a sending/receiving section (not shown) being provided.

In view of the above-described structure, hereinafter, an image taking operation of the image taking apparatus 40 of Embodiment 2-1 will be described.

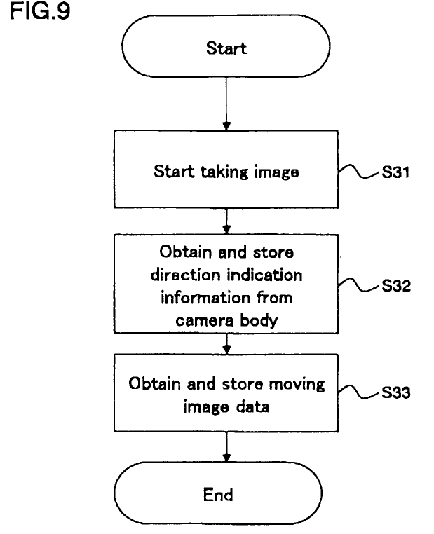

FIG. 9 is a flow diagram showing a process procedure of the image taking operation of the image taking apparatus 40 of Embodiment 2-1. The process procedure is stored in a ROM provided in the moving image forming section 44 as a control program. The control program is referred to by a CPU provided in the moving image forming section 44 to perform the process.

As shown in FIG. 9, in step S31, the image taking section 42 receives an instruction to start taking a moving image from the recording button 41. In step 832, the direction indication information is obtained from the direction indicating section 46 and stored in the moving image recording section 47 (external storage device). In this way, the information indicating the vertical direction of the moving image (direction indication information) which is designated to be input by the user when the image is taken from the direction indicating section 46 is obtained at the moving image recording section 47 (external storage device). The information is stored in the moving image recording section 47 (external storage device) as one of the attributes of the image data.

Thereafter, in step S33, the moving image data is obtained and stored. At this time, normal image data is stored in the external storage device with the direction indication information. Obtaining and storing moving the image data in step S33 are continued until shooting of moving image is stopped. However, obtaining and storing the direction indication information in step S32 is performed only when shooting is started. Thus, performing a process of step S31 once is the only added process to the process of normal video cameras.

As described above, according to Embodiment 2-1, an image itself is stored as image data as it is without changing the direction. The direction indication information indicating the original upper side (or lower side) (vertical direction) of the image is designated by the user as an attribute information of the taken image. The direction indication information is stored with the image data. Thus, processing while the image is being taken can be minimized, and a signal process apparatus which can process at a high speed is not required as in the conventional art.

When a moving image is being taken, the vertical direction of the moving image can be designated for reproduction when shooting of the moving image is started. The time it takes for such a process is not proportional to the time period of shooting. Thus, it is possible to allow for the lowering of electric power consumption of electronic information equipment, such as cell-phones.

### Embodiment 2-2

In Embodiment 2-2, an image displaying apparatus for displaying moving images taken by the image taking apparatus 40 will be described.

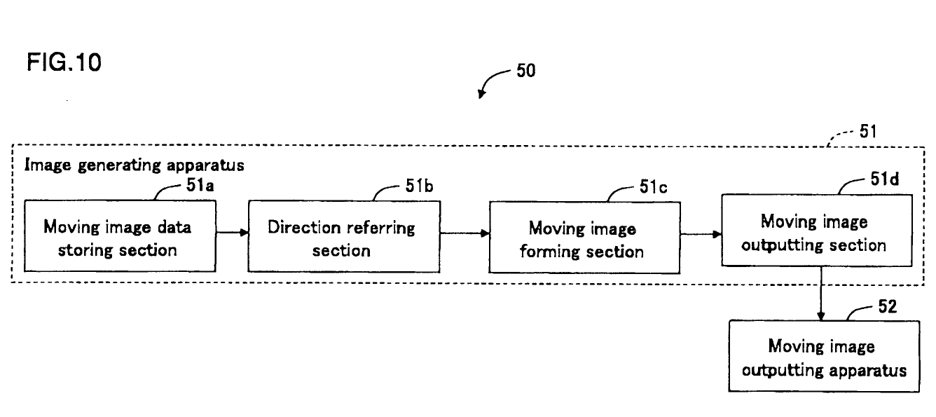

FIG. 10 is a block diagram showing an exemplary structure of an image displaying apparatus of Embodiment 2-2.

As shown in FIG. 10, an image displaying apparatus 50 has: an image generating apparatus 51 including a moving image data storing section 51a, a direction referring section 51b, a moving image forming section 51a and a moving image outputting section 51d; and a moving image outputting section S2 as a displaying section. The image displaying apparatus 50 designates the direction of the taken moving image to display the moving image on a display screen. Basically, the structure of the image displaying apparatus 50 is the same as that shown in FIG. 4 with the portion which supports still images being made to support moving images.

The moving image data storing section 51a is formed of, for example, an external memory card or the like, and stores image data of the moving image taken by the image taking apparatus 40 of the present invention. In the moving image data storing section 51a, information indicating the direction along which the image should be displayed (direction indication information) is stored with the image data. The direction indication information is referred to by the direction referring section 51b.

In the image forming section 51a, image data of the moving image stored in the moving image data storing section 51a is read out, and the image is rotated as necessary such that the side which should be on the upper (or lower) side is displayed on the upper (lower) side in accordance with the direction indication information from the direction referring section 51b to form display data. If it is not necessary, the image is not rotated and is formed as display data in the same direction. The display data is output from the moving image outputting section 51d, and is sent to the moving image outputting apparatus 52 such as a liquid crystal display device.

When reference to the taken image data is made by television equipment, for example, screen display on equipment is not necessary. Thus, in such a case, the moving image outputting apparatus 52 is not provided in the image displaying apparatus 50, and instead, the apparatus may be formed as an image generating apparatus which is the image generating apparatus 51 including only the moving image data storing section 51a, the direction referring section 51b, the moving image forming section 51c, and the moving image outputting section 51d. In this case, an output moving image signal from the moving image outputting section 51d may be sent to the external display device such as television equipment in an appropriate television format, and is displayed.

In view of the above-described structure, hereinafter, an image displaying operation by the image displaying apparatus 50 of Embodiment 2-2 will be described.

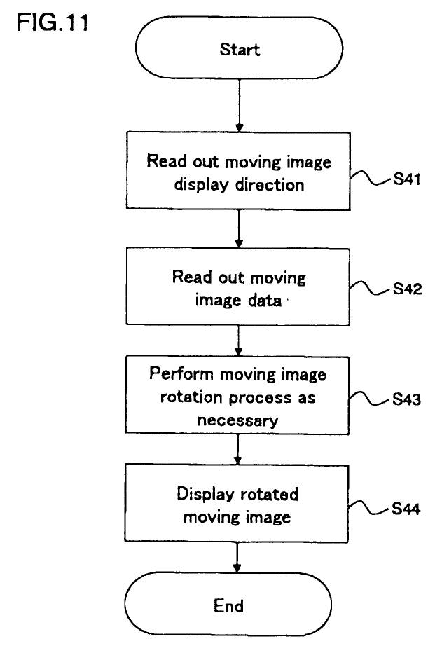

FIG. 11 is a flow diagram showing a process procedure of the image displaying operation by the image displaying apparatus 50 of Embodiment 2-2. The process procedure is stored in, for example, a ROM provided in the moving image forming section 51c as a control program. A CPU provided in the moving image forming section 51a refers to the control program, and process steps are performed.

In step S41, direction indication information which is one of the attributes of the image data stored in the moving image data storing section 51a is read out to the direction referring section 51b. Next, in step S42, the image data stored in the moving image data storing section 51a is read out to the moving image forming section 51a. These operations may be performed in the reversed order.

Then, in stop S43, for forming the image data read out at step S42 by the moving image forming section 51a, reference to the direction indication information read out at step S41 is made, and the image is rotated as necessary in accordance with the information. In some cases, it is not necessary to rotate the image depending upon the direction of the camera when the image is taken. In such cases, the image is displayed without being rotated. The same is also true of the case where no direction indication information indicating the vertical direction of the image exists (the image is displayed without being rotated).

Thereafter, in step S44, the image data after rotation (display data) is supplied to the moving image outputting apparatus 52 from the moving image outputting section 51d, and the image is displayed on the display screen.

In this embodiment the processes are sequentially performed. However, the processes in steps S42 through S44 can be provided for each of an appropriate data amount, for example, each of the still images forming the moving image. In such a case, these three steps are repeated for all the data of the moving image. The process of step 41 is performed only once even in such a case.

As described above, according to Embodiment 2-2, the image data can be rotated as necessary with reference to the direction indication information to generate display data in the original direction. In this way, the image can be reproduced in the direction intended by the user of the image taking apparatus.

### Embodiment 2-3

In Embodiment 2-3, an image printing apparatus for printing moving images taken by the image taking apparatus 40 according to the present invention will be described.

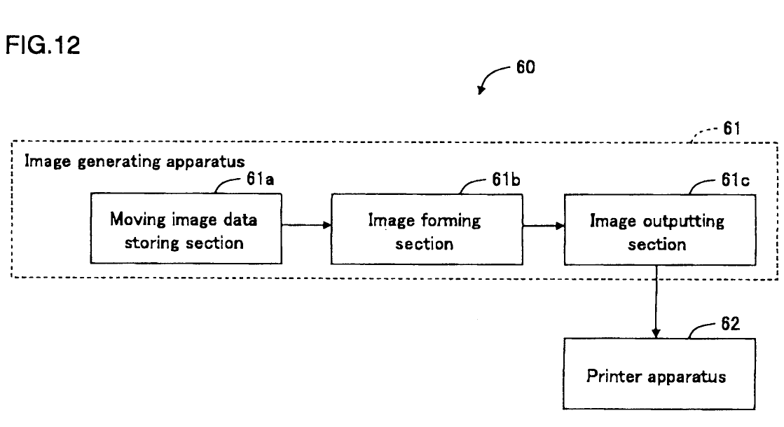

FIG. 12 is a block diagram showing an exemplary basic structure of an image printing apparatus of Embodiment 2-3.

As shown in FIG. 12, an image printing apparatus 60 has: an image generating apparatus 61 including a moving image data storing section 61a, an image forming section 61b, and an image outputting section 61a; and a printer apparatus 62 as a printing section. The image printing apparatus 60 prints moving images of the same shape having the wide sides and narrow sides on the same side, which are taken by the image taking apparatus 40.

The image data storing section 61a may be, for example, external memory cards, and stores image data of still images taken by the image taking apparatus 40 of the present invention. The moving image data storing section 61a also stores information indicating the direction along which the image should be displayed (direction indication information) with the image data. In Embodiment 2-3, the direction indication information is not used, and only the image data is used.

In the image forming section 61b, a scene designated from the image data of the moving image stored in the image data storing section 61a is taken out as a still image and formed as print data.

The image data is image data itself as it is taken by the image taking apparatus 40 such as digital video cameras. Thus, in the case where the horizontal direction is a normal image direction, even when images are taken by the image taking apparatus 40 of the present invention and it is designated that the direction indication information points in a direction different from the normal image direction, still images, which respectively represent one scene of the moving image designated and out therefrom which is taken by the same equipment, may be images of the same shape (having the same number of pixels in both the vertical direction and the horizontal direction) are obtained. When the image display direction is not considered, images taken by the same type of digital camera does not include both vertically long images and horizontally long images.

Then, the image outputting section 61a converts the image into image data suitable for the printer apparatus 62 and sent out to the printer apparatus 62.

In Embodiment 2-3, the image forming section 61b forms image data, and the image outputting section 61a converts the image data into image data suitable for the printer apparatus 62. However, the border between the image forming section 61b and the image outputting section 61a may be vague in some cases. Even in such cases, reference is made to only the image data among the image data stored in the moving image data storing section 61a and the direction indication information, and the image is not rotated unlike when images are displayed.

In view of the above-described structure, hereinafter, an image printing operation by the image printing apparatus 60 of Embodiment 2-3 will be described.

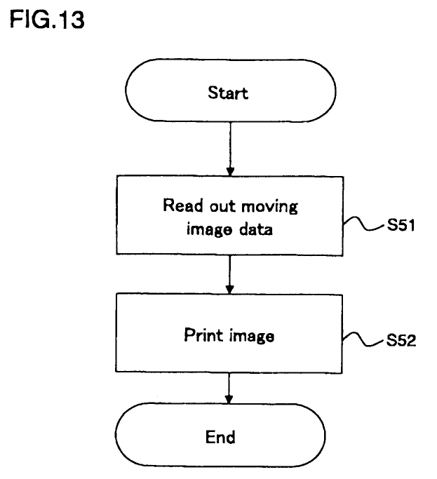

FIG. 13 is a flow diagram showing a process procedure of the image printing operation by the image printing apparatus 60 of Embodiment 2-3. The process procedure is stored in, for example, a ROM provided in the image forming section 61b as a control program. The control program is ref erred by a CPU provided in the image forming section 61b to perform process steps.

As shown in FIG. 13, in step S51, a scene of at the designated position from the moving image stored in the moving image data storing section 61a is taken out as a still image, and image data thereof is read out to the image forming section 61b to form image data. The image data is converted by the image outputting section 61a into the data suitable for the printer apparatus 62. Even when the direction indication information exists with the image data, the direction indication information is not used, and the image is not rotated.

Then, in step 852, the image data (print data) is supplied to the printer apparatus 62, and the image is printed on paper.

As described above, according to Embodiment 2-3, the reference is made to only the image data among the image data and the direction indication information, and image is not rotated depending upon the direction indication information. Thus, images as they are taken by the image taking apparatus 40 which have the same shape with the wide side and narrow aide on the same side are printed on paper. Accordingly, for feeding paper to the printer apparatus 62, it is not necessary to switch paper depending upon images. An inexpensive printer apparatus 62 which cannot perform automatic paper selection requires effort for switching paper when paper in both vertical and horizontal directions is used. However, when the images are output along one same direction, paper may be fed to the printer apparatus 62 in one direction. Since it is easy to rearrange the direction of paper after printing manually, effort and coat can be saved.

### Embodiment 3

In Embodiment 3, another example of the image taking apparatus in which a plurality of shutter buttons of a digital camera or recording start buttons of a digital video camera are provided and associated with direction indication information.

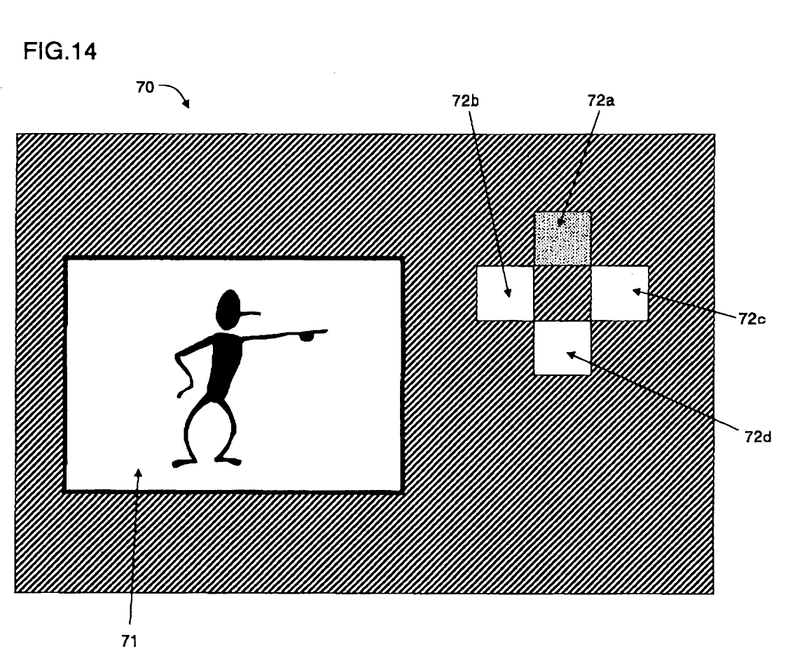

FIG. 14 is a schematic diagram showing an operating section in an image taking apparatus of Embodiment 3.

As shown in FIG. 14, an operating section 70 of the image taking apparatus of Embodiment 3 includes a monitor portion 71, and shutter buttons or recording start buttons 72a through 72d. The operating section 70 forms a direction indicating section 6 or 46.

The monitor portion 71 displays still images or moving images which are actually taken.

The buttons 72a through 72d are respectively associated with upper side, left aide, right side and lower side of the monitor portion 71. The buttons 72a through 72d are used for designating each of the aides to be on the upper side with respect to vertical direction.

With such a structure, for example, an image having the upper side on the upper side with respect to vertical direction is displayed on the monitor portion 71. When it is desired that the image is displayed similarly when being reproduced, shooting of the image can be performed by operating the button 72a. By operating one of four buttons as such, the direction indication information indicating vertical direction of video (image) can be designated, and to start shooting can be instructed with only one operation.

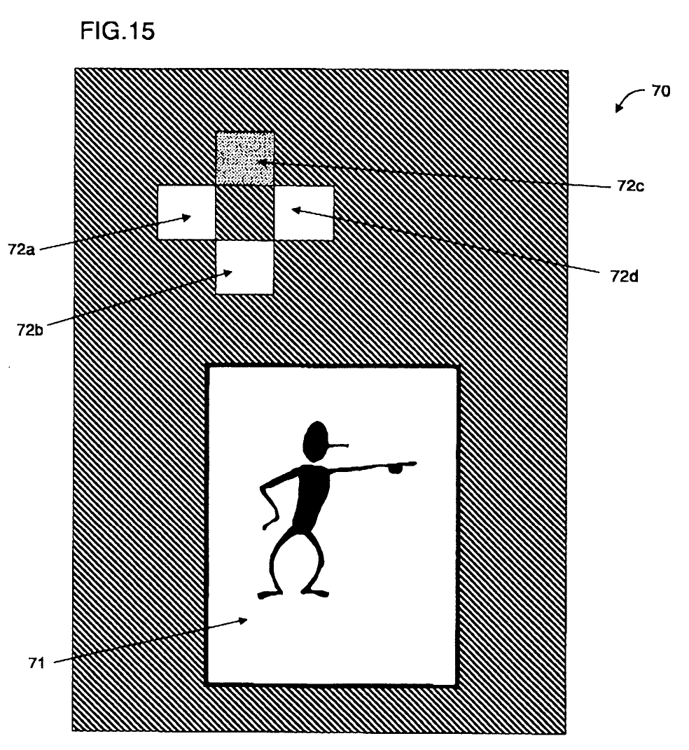

FIG. 15 is 8 schematic diagram showing the operating section 70 when the image taking apparatus of FIG. 14 is held vertically.

As shown in FIG. 15, an image rotated in a right direction by 90 degrees compared to that shown in FIG. 14 is displayed on the monitor portion 71. When it is desired to display the image similarly when being reproduced, the button 72a which indicates the upper side of the image is operated to start shooting and instruct direction at the same time. By selecting and operating one of four buttons as such, the direction indication information indicating the vertical direction of video (image) can be designated and start of recording can be instructed with only one operation.

In view of the above-described structure, hereinafter, an image taking operation by the operating section 70 of the image taking apparatus of Embodiment 3 will be described.

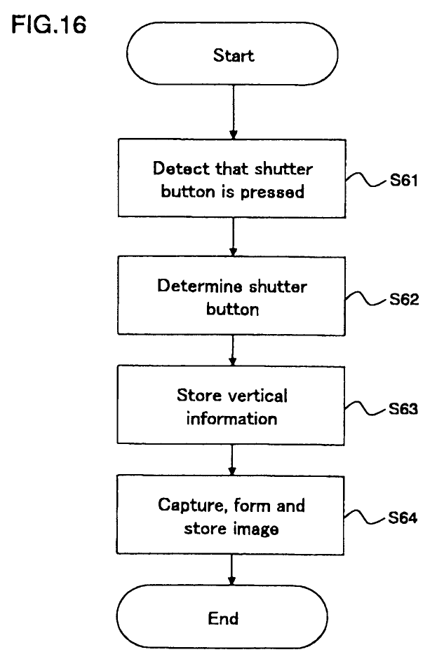

FIG. 16 is a flow diagram showing a process procedure of a program when the image taking apparatus of Embodiment 3 is a digital camera for taking still images.

As shown in FIG. 16, first, in step S61, it is detected that the shutter button is pressed. In step S62, it is determined that shooting is performed by pressing which of the plurality of shutter buttons.

Next, in step S63, direction indication information (vertical direction information) of the image associated to the button is stored as an attribute of the image to be stored. Then, in step S64, similar to a shooting process by normal digital cameras, image data is obtained and formed for storage.

As described above, when still images are being taken, the shutter buttons can also serve as the direction indicating section which instructs vertical direction of the images. Further, the positions of the shutter buttons may be considered well. For example, the shutter button corresponding to the vertical direction may be arranged on the upper right corner no matter how the camera is being held. Even when an image is taken with the camera being rotated by a degree of multiples of 90, the person who takes the images can record/store the direction of the image (direction indication information) with the image data without the person taking the images thinking of such a function.

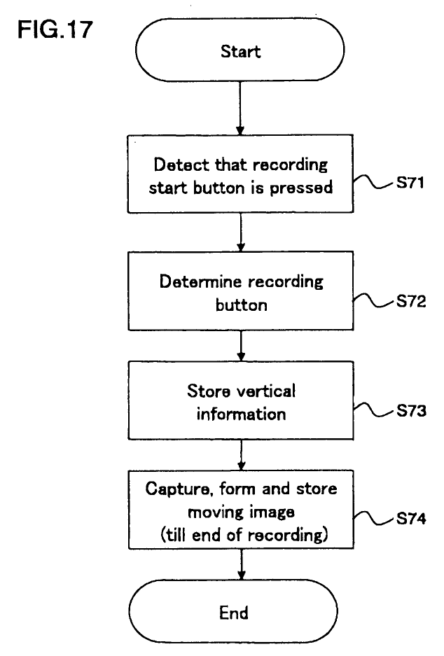

FIG. 17 is a flow diagram showing a process procedure of a control program when the image taking apparatus of Embodiment 3 is a digital video camera.

As shown in FIG. 17, first, in step S71, it is detected that the start button is pressed. In step S72, it is determined which of the plurality of recording start buttons is pressed to start recording.

Next, in step S73, the direction indication information (vertical direction information) of the image which is associated to the button is stored as the attribute of the moving image to be stored. Then, in step S74, similar to the shooting process by a normal digital video camera, moving image data in obtained, formed and stored repeatedly until the recording stop instruction is issued.

In this way, similar to the case where still images are being taken, when moving images are being taken, the recording start buttons can also serve as the direction indicating section for instructing the vertical direction of the images to record/store the direction of the images (direction indication information) with the image data.

An described above, according to Embodiments 1-through 3, when an image is taken, information indicating upper side or lower side (vertical direction) of the image can be designated by a user of the image taking apparatus from a direction indicating section, and the direction indication information is recorded in an image recording section with the image data. At this time, the image data is stored as it is without rotating the image. When the image is displayed, a reference is made to the direction indication information which is stored with the image data and the image data (direction of the image) is rotated as necessary. When the image is printed, the image is not rotated irrespective of direction indication information. In this way, both still images and moving images can be reproduced in the direction intended by the user with low throughput.

When a moving image is recorded, it is necessary to instruct to stop recording. However, the number of the end instruction buttons may be the same as that of the recording start buttons (as functions) if the end instruction buttons are such that the recording is continued while the recording start buttons are being pressed. In the case where end instruction buttons are separately provided, the number is not limited to be the same as the number of instruction direction buttons. Only one and instruction button may be provided. This is because the direction information is obtained when shooting is started, and thus, the only information required when shooting is finished is end of shooting.

In the above Embodiments 1 and 2, the case where the image data and the direction indication information are sent/received via a communication path with a sending/receiving section (not shown) being further provided is described. More specifically, for example, when the image taking apparatus 10 (or 40) and the image displaying apparatus 20 (or 50) is provided one of two cell phones, the image data and direction indication information of the present invention may be sent from one of the cell phones, received by the other call phone, and displayed on a display screen of the image displaying apparatus 20 (or 50) of the other cell phone.

Furthermore, although there is no particular description in above Embodiments 1 through 3, readable recording media of the present invention may be small portable readable recording media such as 1C memories, optical discs (CD), magnetic recording media and the like as ROMs, and may be readable recording media from which the control program of the present invention is readable. The control program which is read out is stored in the RAMs of working memory, and it becomes possible that process steps are performed by a central processing unit (CPU).

As described above, the present invention has been described with reference to preferred Embodiments 1 through 3 of the present invention. However, the present invention should not be construed that it is limited to these Embodiments 1 through 3. It is recognized that the scope of the present invention should be construed with reference to only the claims. It is recognized that those skilled in the art can embody an equivalent scope from the descriptions of preferred Embodiment 1 through 3 of the present invention based on description of the present invention and common technical knowledge. Patents, patent applications and document mentioned in the present specification should be herein incorporated as if the contents thereof are specifically described in the present specification.

In the field of: an image taking apparatus which can take digital images, and an image taking method using the same; an image generating apparatus for generating display data or print data from image data taken by such an image taking apparatus, and an image generating method using the same; an image displaying apparatus for displaying display data obtained by such an image generating apparatus on a monitor; an image printing apparatus for printing print data obtained by such an image generating apparatus by a printer apparatus or the like; a control program for processing such methods on a computer; and a readable storage medium having such a control program stored therein, the present invention allows not only still images but also moving images displayed in a direction intended by a user of the image taking apparatus with a low throughput and low electric power consumption. When images are printed, direction of paper does not have to be switched, or a printing process is separated into groups of images according to the types of the images. In this way, effort and cost can be reduced. The present invention can be used for digital cameras, digital video cameras, and camera-equipped cell-phones. Various applications such as viewing the images taken by such an image taking apparatus on television equipment as a monitor by a number of people, having communication by sending/receiving images, may be considered.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image taking apparatus comprising:
an image taking section for taking a still image or moving image;
a direction indicating section for designating a direction of an image while the image is being taken; and
an image recording section for recording the direction designated by the direction indicating section as direction indication information with image data taken by the image taking section.

2. An image taking apparatus according to claim 1, further comprising a sending/receiving section which allows sending/receiving of the direction indication information with the image data via a communication path.

3. An image taking apparatus according to claim 1, wherein the direction indicating section also serves as a shutter button or a recording start button, and a plurality of the direction indicating sections are provided so as to be associated with the direction of the image.

4. An image taking apparatus according to claim 1, wherein the direction of a rotation is a vertical direction of the image.

5. An image generating apparatus for generating display data from the image data taken by the image taking apparatus according to claim 1, comprising:
an image data storing section for storing the direction indication information with the image data;
a direction referring section for referring to the direction indication information from the image data storing section;
an image forming section for reading out the image data from the image data storing section and rotating the image data as necessary in accordance with the direction of the image based on the direction indication information referred to by the direction referring section to generate display data.

6. An image displaying apparatus comprising:
an image generating apparatus according to claim 5; and
a displaying section for displaying the display data generated by the image generating apparatus on a display screen.

7. An image generating apparatus for generating print data from the image data taken by the image taking apparatus according to claim 1, comprising:
an image data storing section for storing the image data; and
an image forming section for reading out the image data from the image data storing section and generating print data irrespective of the direction indication information.

8. An image printing apparatus comprising:
an image generating apparatus according to claim 7; and
a printer section for printing the print data generated at the image generating apparatus on paper.

9. An image taking method comprising the steps of:
(a) taking a still image or a moving image;
(b) allowing output of a direction indicating instruction which designates a direction of an image while the image is being taken; and
(c) recording and storing the direction designated to be output in the step (b) as direction indication information with image data taken in the step (a).

10. An image taking method according to claim 9, further comprising the step of receiving/sending the direction indication information with the image data via a communication path.

11. An image generating method for generating display data from the image data obtained by the image taking method according to claim 9, comprising the steps of:
(d) referring to the direction indication information stored with the image data; and
(e) reading out the image data and rotating the image data as necessary in accordance with the direction of the image based on the direction indication information referred to in step (d) so as to generate display data.

12. An image generating method for generating print data from the image data obtained by the image taking method according to claim 9, comprising the step of reading out the image data and generating print data irrespective of the direction indication information.

13. A control program for operating a computer to perform the steps of the image taking method according to claim 9.

14. A control program for operating a computer to perform the steps of the image generating method according to claim 11.

15. A computer-readable storage medium storing thereon the control program according claim 13.

16. A computer-readable storage medium storing thereon the control program according claim 14.
